(19) United States
(12) Patent Application Publication
(10) Pub. No.: US 2026/0318141 A1
(43) Pub. Date: Oct. 15, 2026

(54) REFRIGERATOR

(71) Applicant: LG Electronics Inc., Seoul (KR)

(72) Inventors: Heejun LEE, Seoul (KR); Jinho CHANG, Seoul (KR); Bohyeon LEE, Seoul (KR)

(21) Appl. No.: 19/553,682

(22) Filed: Mar. 2, 2026

(30) Foreign Application Priority Data
Jan. 2, 2025 (KR) 10-2025-0000368
Apr. 9, 2025 (KR) 10-2025-0045977

(51) Int. Cl. E05F 15/616; F25D 23/02

(52) U.S. Cl. CPC E05F 15/616; F25D 23/028; E05Y 2201/11; E05Y 2900/31

(57) ABSTRACT

A refrigerator includes a cabinet, a door, and a door opening and closing device. The door opening and closing device includes: a frame, a driver, a power transmission portion, a first operating portion configured to operate by receiving the power from the driver, and a second operating portion configured to operate by receiving the power from the driver to open the door to a preset angle. The second operating portion includes: a link gear connectable to the power transmission portion, and a link having one side rotatably connected to the link gear and another side rotatably connected to the door. The frame includes a first frame and a second frame, where the second frame is coupled to the first frame and includes an opening that provides a path for the link to move, and the first frame includes a cover portion that covers a portion of the opening.

### CROSS-REFERENCE TO RELATED APPLICATIONS

This application claims the benefit of Korean Patent Application No. 10-2025-0000368, filed on Jan. 2, 2025, and Korean Patent Application No. 10-2025-0045977, filed on Apr. 9, 2025. The disclosures of the prior applications are incorporated by reference in their entirety.

### FIELD

The present disclosure relates to a refrigerator.

### BACKGROUND

In general, a refrigerator is a home appliance for storing foods in an internal storage space, which is shield by a door, at a low temperature by low temperature air.

The storage space is surrounded by an insulating wall so that an inside of the storage space is maintained at a temperature lower than an outside temperature. Depending on a temperature range of the storage space, the storage space may be called as a refrigerating chamber or a freezing chamber.

To put an object into or take the object out of the storage space, the user opens the door. Typically, the door is rotatably installed on the cabinet, and a gasket is provided between the door and the cabinet. Therefore, when the door is closed, the gasket seals tightly between the door and the cabinet, preventing cold air from leaking from the storage space. A greater a sealing force of this gasket, a greater an effect of preventing cold air from leaking.

To increase a sealing force of the gasket, the gasket may be formed of a rubber, and a magnet may be provided within the gasket. However, as the sealing force of the gasket increases, a greater force is required to open the door.

Accordingly, a refrigerator with automatic door opening functions have recently been introduced. A related prior art document is China Utility Model Registration No. 218324468.

### SUMMARY

One embodiment provides a refrigerator in which a door can be automatically opened and an opening angle of the door increases when the door is automatically opened.

Alternatively or additionally, one embodiment provides a refrigerator in which a door can be automatically opened and closed.

Alternatively or additionally, one embodiment provides a refrigerator in which, upon initial automatic door opening, a first operating portion separates a gasket of a door from a cabinet, thereby reducing excessive load on a driver.

Alternatively or additionally, one embodiment provides a refrigerator in which a door can be opened manually by a user in addition to automatically opening.

Alternatively or additionally, one embodiment provides a refrigerator capable of reducing an entry of foreign substances into a door opening and closing device.

Alternatively or additionally, one embodiment provides a refrigerator capable of reducing exposure of a door opening and closing device to an outside through a slot, which serves as a path for a link, in a cover member covering the door opening and closing device.

Alternatively or additionally, one embodiment provides a refrigerator capable of reducing movement of foreign substances toward a door opening and closing device through a slot, which serves as a path for a link, in a cover member covering the door opening and closing device.

Alternatively or additionally, one embodiment provides a refrigerator capable of limiting sagging of a link or a link gear during an opening and closing process of a door.

A refrigerator according to one aspect may include: a cabinet having a storage space; a door that opens and closes the storage space; and a door opening and closing device to open and close the door.

The door opening and closing device may include: a frame, a driver installed on the frame and configured to generate power, a power transmission portion configured to transmit the power from the driver, a first operating portion configured to operate by receiving the power from the driver, and a second operating portion configured to operate by receiving the power from the driver to open the door to a preset angle.

The second operating portion may include a link gear connectable to the power transmission portion, and a link having one side rotatably connected to the link gear and another side rotatably connected to the door. The frame may include a first frame and a second frame coupled to the first frame.

The second frame may include an opening that provides a path for the link to move.

The first frame may include a cover portion that covers a portion of the opening.

The second frame is positioned at an upper side of the first frame, and the link gear may include a receiving portion formed by one surface being recessed downward so that the link is positioned therein.

A gap between a surface of the second frame forming the opening and an upper surface of the link may be less than a vertical length or a height of the link.

A gap between the cover portion and the link may be less than a vertical length or a height of the link.

The first frame may include a first frame body and a first peripheral portion extending from the first frame body.

A protrusion for preventing sagging of the link gear or the link may be formed on the first frame body.

The protrusion may be formed in an arc shape based on a rotation center of the link gear.

The link is connected to the link gear by a pin, a groove is formed at the second frame, and at least a portion of the groove may be formed in the same shape as a movement trajectory of the pin at a position corresponding to the movement trajectory.

The link gear may include a gear portion, and when the door is in a closed state, a portion of the gear portion may be positioned between the first operating portion and a rotation center of the link gear.

When the door is in the closed state, a rotation center of the link gear may be positioned between a portion of the gear portion and the link.

At least one of the first frame or the second frame may include a link cover portion that covers the link.

The refrigerator may further include a cover member that covers at least a portion of the door opening and closing device and has a slot providing a path through which the link moves.

The refrigerator may further include a shielding member coupled to the cover member to shield a portion of the slot.

The cover member may include a cover body and a peripheral portion extending from the cover body.

The slot may be formed at the peripheral portion, and a first coupling portion for coupling with the shielding member may be formed at the cover body.

The shielding member may include a shielding body to cover the slot and a second coupling portion coupled to the first coupling portion.

In a state in which the shielding body covers the slot, the shielding body may be disposed spaced apart from the link at a lower side of the link.

The peripheral portion may further include an additional slot providing a movement path for the first operating portion.

The first operating portion may include a cover formed of a soft or flexible material, and in a state in which the door is closed, the cover may cover the additional slot.

A refrigerator according to another aspect may include: a cabinet having a storage space; a door that opens and closes the storage space; and a door opening and closing device to open the door. The door opening and closing device may include: a frame; a driver installed on the frame to generate power; a power transmission portion to transmit the power of the driver; a first operating portion operating by receiving the power of the driver; and a second operating portion operating by receiving the power of the driver to open the door to a set angle. The second operating portion may include a link gear connectable to the power transmission portion, and a link having one side rotatably connected to the link gear and another side rotatably connected to the door. The frame includes a first frame and a second frame coupled to the first frame, and each of the first frame and the second frame may include an opening that provides a path for the link to move.

A vertical length or a height of the opening of the second frame may be less than a vertical length or a height of the link.

The second frame is positioned at an upper side of the first frame, and the link gear may include a receiving portion formed by one surface being recessed upward so that the link is positioned therein.

A refrigerator according to still another aspect may include: a cabinet having a storage space; a door that opens and closes the storage space; a door opening and closing device to open the door; and a cover member installed on the cabinet and covering at least a portion of the door opening and closing device. The door opening and closing device may include: a frame; a driver installed on the frame to generate power; a power transmission portion to transmit the power of the driver; a first operating portion operating by receiving the power of the driver; and a second operating portion operating by receiving the power of the driver to open the door to a set angle. The second operating portion may include a link gear connectable to the power transmission portion, and a link having one side rotatably connected to the link gear and another side rotatably connected to the door. The frame includes an opening through which the link passes, the cover member includes a slot through which the link passing through the opening passes, and a portion of the slot may be covered by a shielding member coupled to the cover member.

According to one embodiment, there is an advantage in that a door opening angle increases when the door is automatically opened.

According to one embodiment, there is an advantage in that a door can not only open automatically, but also close automatically.

According to one embodiment, there is an advantage that the door is not only automatically opened but also manually openable by a user.

According to one embodiment, there is an advantage that entry of foreign substances into an inside of the frame, where the link is accommodated, through the opening.

According to one embodiment, since a portion of the slot, which is a path of the link, in the cover member covering the door opening and closing device is shielded by the shielding member, exposure of the door opening and closing device to an outside through the slot or movement of foreign substances toward the door opening and closing device through the slot can be reduced.

According to one embodiment, since a frame includes a protrusion for limiting sagging of the link gear or the link during the opening and closing process of the door, direct friction between a link gear or a link and the frame can be reduced.

### BRIEF DESCRIPTION OF THE DRAWINGS

FIG. 1A is a plan view of a refrigerator according to a first embodiment, and FIG. 1B is a drawing showing a state in which a cover member in FIG. 1A is removed.

FIG. 2A is a drawing showing a state in which a door opening and closing device and a cover member are separated from a refrigerator according to a first embodiment. FIG. 2B is a drawing showing a state in which a door opening and closing device and a cover member are installed at a refrigerator according to a first embodiment.

FIG. 3 is a perspective view illustrating a state in which a door opening and closing device is installed on a cover member according to a first embodiment.

FIG. 4 is a perspective view of a refrigerator illustrating a state in which a second frame is removed from the door opening and closing device installed at the refrigerator according to a first embodiment.

FIG. 5 is a plan view of a door opening and closing device according to a first embodiment.

FIG. 6 is a front view of a door opening and closing device according to a first embodiment.

FIG. 7 is a perspective view of a first frame according to a first embodiment.

FIGS. 8 and 9 are perspective views of a second frame according to a first embodiment.

FIG. 10 is a perspective view of a cover member according to a first embodiment.

FIG. 11 is an enlarged view of portion A of FIG. 10.

FIGS. 12 and 13 are perspective views of a shielding member according to a first embodiment.

FIG. 14 is a view partially illustrating a state in which a door opening and closing device is coupled to the cover member according to a first embodiment.

FIG. 15 is a view illustrating a state in which a shielding member is coupled in FIG. 14.

FIG. 16 is a front view illustrating a state in which a cover member is installed at a refrigerator according to a first embodiment.

FIG. 17 is a plan view illustrating a door opening and closing device in a state in which a door is opened by a maximum opening angle according to a first embodiment.

FIG. 18 is a front view of a door opening and closing device according to a second embodiment.

FIG. 19 is a perspective view of a second operating portion according to a second embodiment.

FIG. 20 is a perspective view of a second frame according to a third embodiment.

### DETAILED DESCRIPTION

Hereinafter, some embodiments of the present disclosure will be described in detail with reference to the accompanying drawings. It should be noted that when components in the drawings are designated by reference numerals, the same components have the same reference numerals as far as possible even though the components are illustrated in different drawings. Further, in description of embodiments of the present disclosure, when it is determined that detailed descriptions of well-known configurations or functions disturb understanding of the embodiments of the present disclosure, the detailed descriptions will be omitted.

Also, in the description of the embodiments of the present disclosure, the terms such as first, second, A, B, (a) and (b) may be used. Each of the terms is merely used to distinguish the corresponding component from other components, and does not delimit an essence, an order or a sequence of the corresponding component. It should be understood that when one component is “connected”, “coupled” or “joined” to another component, the former may be directly connected, coupled or joined to the latter or may be “connected”, coupled” or “joined” to the latter with a third component interposed therebetween.

In this specification, at least one of component A and component B may be interpreted as including component A, component B, or components A+B.

Furthermore, at least one of component A or component B may be interpreted as including component A, component B, or components A+B.

In this specification, a front surface of the door is a surface forming a front appearance of the door, and a rear surface of the door is a surface facing a cabinet or storage space.

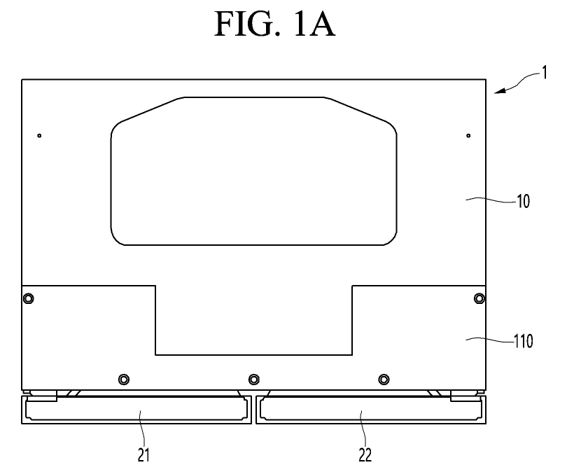

FIG. 1A is a plan view of a refrigerator according to a present embodiment, and FIG. 1B is a drawing showing a state in which a cover member in FIG. 1A is removed.

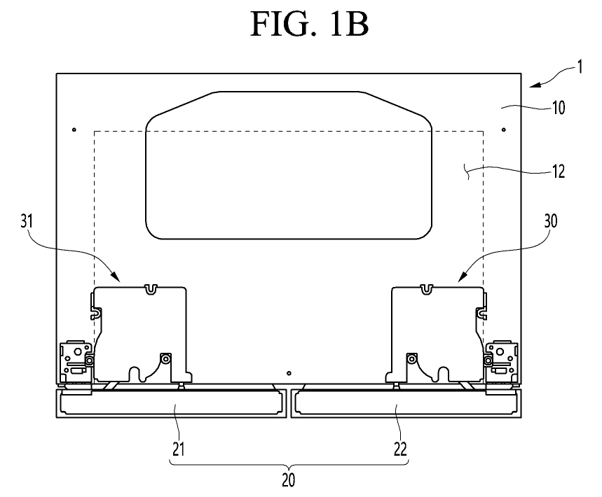

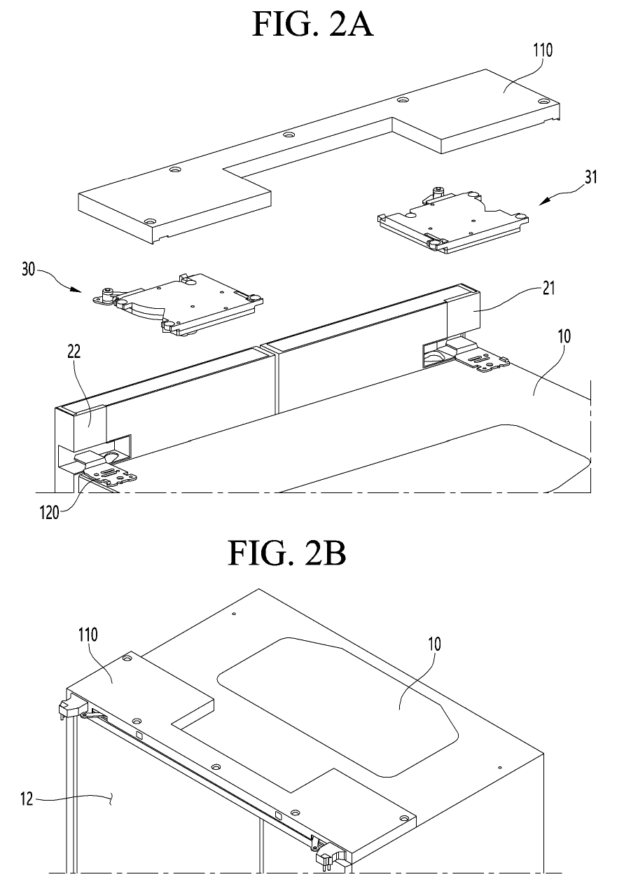

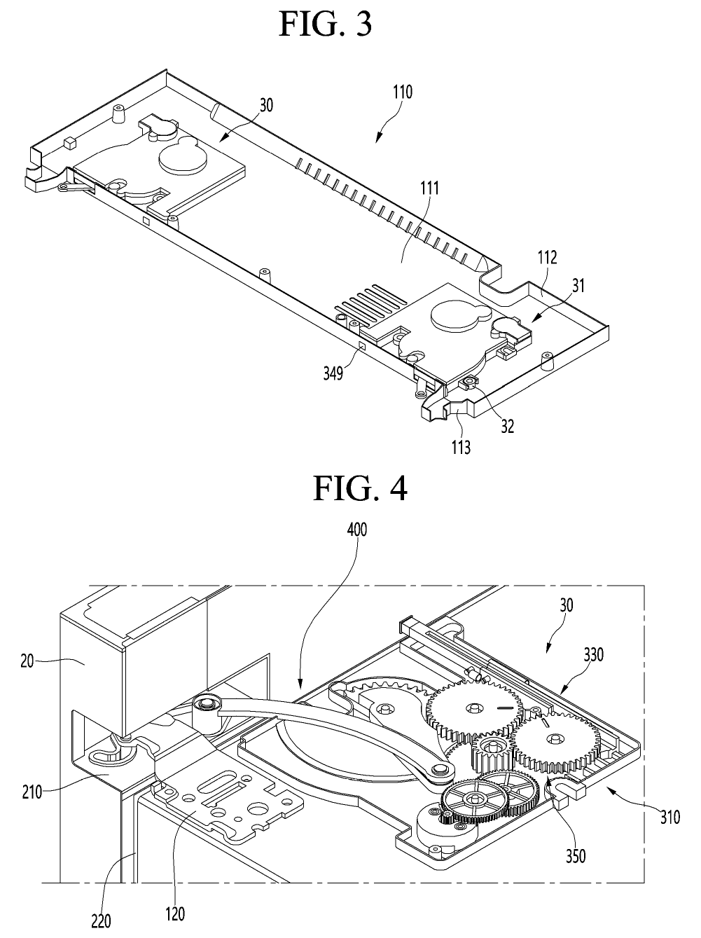

FIG. 2A is a drawing showing a state in which a door opening and closing device and a cover member are separated from a refrigerator according to a present embodiment. FIG. 2B is a drawing showing a state in which a door opening and closing device and a cover member are installed at a refrigerator according to a present embodiment. FIG. 3 is a perspective view illustrating a state in which a door opening and closing device is installed on a cover member according to a first embodiment.

Referring to FIGS. 1 to 3, a refrigerator 1 according to the present embodiment may include a cabinet 10 to form a storage space 12 and a door 20 that opens and closes the storage space 12.

The storage space 12 may include, for example, a refrigerating chamber. Alternatively, the storage space 12 may include, for example, a freezing chamber. Alternatively, although not shown, the storage space 12 may further include an additional storage space.

The door 20 may be a refrigerating chamber door or a freezing chamber door. The door 20 may include a first door 21 that opens and closes a portion of the storage space 12. The door 20 may further include a second door 22 that opens and closes another portion of the storage space 12. Alternatively, a single door 20 may open and close a single storage space 12, or may open and close multiple storage spaces 12 simultaneously.

Each of the first door 21 and the second door 22 may be configured as a single door. Alternatively, at least one of the first door 21 or the second door 22 may include a main door and a sub-door.

A refrigerator of the present embodiment may further include a door opening and closing device 30, 31 to open the door 20. When the door 20 includes a plurality of doors 21, 22, the door opening and closing device 30, 31 may open some or all of the plurality of doors 21, 22. When the refrigerator 1 includes a single door 20, the refrigerator 1 may include a single door opening and closing device.

As an example, FIG. 1 illustrates that the first door 21 and the second door 22 are automatically opened and closed by door opening and closing devices 30 and 31, respectively. That is, the refrigerator 1 may include a first door opening and closing device 30 and a second door opening and closing device 31.

Each of the door opening and closing devices 30 and 31 may be arranged symmetrically and have the same structure.

Each of the first door 21 and the second door 22 may be rotatably connected to the cabinet 10 by a hinge device 120.

The hinge device 120 may be installed, for example, on an upper surface of the cabinet 10. Accordingly, a pair of hinge devices 120 may be spaced apart from each other on the upper surface of the cabinet 10.

The hinge device 120 may include a pin unit. The pin unit may include a plurality of pins that are spaced apart from each other. When the pin unit includes a plurality of pins, a rotation center of the door 20 may move during an opening and closing process of the door 20.

As another example, the pin unit may include a single pin. When the pin unit includes a single pin, a rotation center of the door 20 may be fixed in position during an opening and closing process of the door 20.

As another example, a multi-joint hinge unit including a plurality of bodies may be used as the hinge device 120.

Each of the door opening and closing devices 30, 31 may be positioned at an upper side of the cabinet 10. Each of the door opening and closing devices 30, 31 may be positioned adjacent to each hinge device 120 between the pair of hinge devices 120.

As another example, it is also possible for the door opening and closing device 30, 31 to be positioned at a bottom or side of the cabinet 10. Alternatively, it is also possible for the door opening and closing device 30, 31 to be received within the cabinet 10, and for a structure for opening the door to be protruded outside the cabinet 10.

The refrigerator 1 may further include a cover member 110. The cover member 110 may be installed on an upper surface of the cabinet 10.

The cover member 110 may cover at least a portion of each of the door opening and closing devices 30 and 31. The cover member 110 may cover at least a portion of the hinge device 120.

Each of the door opening and closing devices 30 and 31 may be installed on the upper surface of the cabinet 10 or may be installed at the cover member 110. When each of the door opening and closing devices 30 and 31 is installed at the cover member 110, the cover member 110 may be installed on the upper surface of the cabinet 10 after each of the door opening and closing devices 30 and 31 is installed at the cover member 110.

In the present embodiment, a single cover member 110 may cover a pair of door opening and closing devices 30, 31 and a pair of hinge devices 120 simultaneously, but is not limited thereto. For example, a plurality of cover members 110 may individually cover each of a pair of door opening and closing devices 30, 31 and a pair of hinge devices 120.

The cover member 110 may include a cover body 111. The cover member 110 may include a peripheral portion 112 extending from the cover body 111. For example, the peripheral portion 112 may extend downward from a peripheral edge of the cover body 111.

The cover member 110 may further include a hinge cover 113 that covers at least a portion of the hinge mechanism 120. The hinge cover 113 may be integrally formed with the cover member 110, or may be formed separately from the cover member 110 and coupled to the cover member 110.

The door opening and closing device 30, 31 may include a buffer member 32. The buffer member 32 may absorb vibrations generated during an operation of the door opening and closing device 30, 31 or may reduce transmission of vibrations to the cover member 110 installed on the cabinet 10, thereby reducing noise caused by the vibrations. The buffer member 32 may be coupled to the cover body 111. A detailed structure of the cover member 110 will be described later with reference to the drawings.

Hereinafter, the door opening and closing devices 30 and 31 will be described in detail. At this time, the door opening and closing devices 30 and 31 will be collectively referred to as “door opening and closing device 30.”

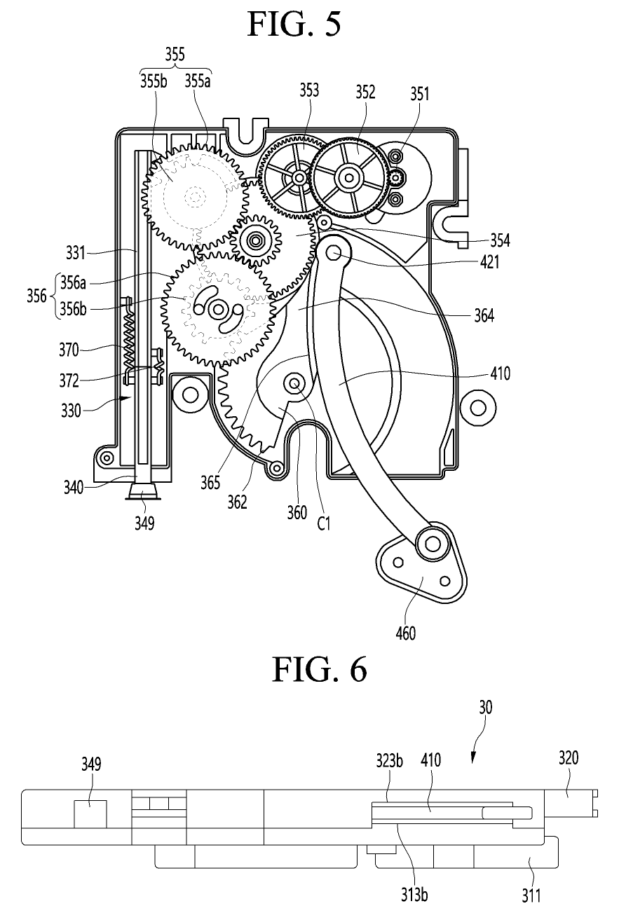

FIG. 4 is a perspective view of a refrigerator illustrating a state in which a second frame is removed from the door opening and closing device installed at the refrigerator according to a first embodiment. FIG. 5 is a plan view of a door opening and closing device according to a first embodiment.

In FIG. 4, a cover member and a second frame are removed. In FIG. 5, a second frame is removed.

Referring to FIGS. 4 and 5, in the present embodiment, the door 20 can be automatically opened by the door opening and closing device 30. Alternatively, the door 20 can be manually opened by a user.

A portion of the door opening and closing device 30 may be connected to an upper side (or lower side) of the door 20.

A gasket 220 may be provided between the door 20 and the cabinet 10 to limit leakage of cold air from the storage space 12. For example, the gasket 220 may be coupled to the door 20. A magnet may be provided inside the gasket 220. The gasket 220 may be maintained in contact with the cabinet 10 by the magnet.

The door 20 may be rotatably connected to the cabinet 10 by the hinge device 120. The door 20 may include a hinge mounting portion 210. The hinge mounting portion 210 may be formed by a rear surface of the door 20 being recessed toward the front. Alternatively, the hinge mounting portion 210 may be formed by one surface of both side surfaces of the door 20 being recessed toward another surface.

The hinge device 120 may be installed at a bottom of the hinge mounting portion 210. The hinge mounting portion 210 may be provided with a pin slot to receive the pin unit, or a guide member to form the pin slot. When the pin unit includes a plurality of pins, the guide member may include a plurality of pin slots or a single pin slot.

The door opening and closing device 30 may include a driver 302. The driver 302 may include a motor. The driver 302 may include, for example, a bidirectionally rotatable motor. The motor may, for example, rotate in both directions. The driver 302 may be controlled by a driver printed circuit board (PCB) 304.

The door opening and closing device 30 may further include a power transfer portion 350 to transfer power from the driver 302.

The door opening and closing device 30 may further include a first operating portion 330 (or first door opening portion) that operates by receiving power from the power transfer portion 350.

The door opening and closing device 30 may further include a second operating portion 400 (or second door opening portion) that operates by receiving power from the power transfer portion 350.

In an automatic opening process of the door 20, the first operating portion 330 and the second operating portion 400 may operate sequentially. The second operating portion 400 functions as a door closing portion to close the door during an automatic closing process.

The power transfer portion 350 may include a plurality of gears.

The door opening and closing device 30 may further include a frame 310. A plurality of gears may be rotatably supported on the frame 310. The driver 302 may be installed on the frame 310.

The frame 310 may cover or support at least a portion of a component constituting the door opening and closing device 30.

For example, the plurality of gears may include first to sixth gears 351, 352, 353, 354, 355, and 356. However, it should be noted that there is no limitation on a number of multiple gears in this embodiment. Furthermore, it should be noted that there is no limitation on shape of the multiple gears.

A first gear 351 may be connected to a shaft of the driver 302. The second to sixth gears 352 to 356 may be reduction gears. A second gear 352 may be connected to the first gear 351. A third gear 353 may be connected to the second gear 352. A fourth gear 354 may be connected to the third gear 353. A fifth gear 355 may be connected to the fourth gear 354. A sixth gear 356 may be connected to the fourth gear 354.

The fifth gear 355 may transfer power to the first operating portion 330. Therefore, the fifth gear 355 may be referred to as a first transfer gear or a first transfer portion.

The sixth gear 356 may transfer power to the second operating portion 400. Therefore, the sixth gear 356 may be referred to as a second transfer gear or a second transfer portion.

At least one of the second to sixth gears 352 to 356 may be a two-stage gear having portions with different diameters.

The fifth gear 355 may transfer power to the first operating portion 330 during a portion of an automatic opening process of the door 20. For example, the fifth gear 355 may transfer power to the first operating portion 330 during an initial process of the automatic opening process. The fifth gear 355 may block power transmission to the first operating portion 330 during another process of the automatic opening process. That is, the fifth gear 355 may block power transferred to the first operating portion 330 during a rotation process. Therefore, the fifth gear 355 may be referred to as a first clutch gear.

The fifth gear 355 may include a first portion 355a and a second portion 355b. A diameter of the first portion 355a may be different from a diameter of the second portion 355b. Gear teeth may be formed entirely around a periphery of the first portion 355a. The first portion 355a may be engaged with the fourth gear 354. The second portion 355b may have gear teeth formed only on a portion of a circumference thereof. That is, the fifth gear 355 may include a partial gear.

The second portion 355b may be selectively connected to the first operating portion 330. In a state in which the second portion 355bconnected to the first operating portion 330, a rotational force of the fifth gear 355 may be transferred to the first operating portion 330.

The sixth gear 356 may transmit power received from the fourth gear 354 to the link gear 360, which will be described later. In this case, the sixth gear 356 may be designed such that a timing of receiving the power from the fourth gear 354 is different from a timing of transferring the power to the link gear 360.

For example, the sixth gear 356 may include a first portion 356aand a second portion 356b. A diameter of the first portion 356amay be different from a diameter of the second portion 356b.

Gear teeth may be formed entirely around a periphery of the first portion 356a. The first portion 356amay be engaged with the fourth gear 354. The second portion 356bmay have gear teeth formed only on a portion of a circumference thereof. That is, the sixth gear 356 may include a partial gear.

The first portion 356a may be connected to the second portion 356b to be relatively rotatable. For example, one of the first portion 356a and the second portion 356b may include a protrusion, and the other may include a slot in which the protrusion is received. In this case, the slot may be formed in an arc shape to guide movement of the protrusion. A length of the slot may be greater than a size or a diameter of the protrusion.

While the first portion 356a is rotating, when the protrusion is in contact with one of both end walls of the slot, the first portion 356a and the second portion 356b may rotate together.

The first operating portion 330 may receive power from the driver 302 while connected to the fifth gear 355.

The first operating portion 330 may be movably installed at the frame 310 in a first axial direction. The first axial direction may be, for example, an arrangement direction of the door 20 and the cabinet 10 or a front-back direction of the refrigerator 1.

The first operating portion 330 may receive power from the driver 302 during an initial process of the automatic opening process to separate the gasket 220 from the cabinet 10.

The first operating portion 330 may include a first member 331. The first member 331 may be selectively connected to the fifth gear 355. The first member 331 may be referred to as a rack. The first member 331 may include a rack gear for being connected to the fifth gear 355.

The first operating portion 330 may further include a second member 340. The second member 340 may push the door 20 in an automatic opening process of the door 20.

The first member 331 and the second member 340 may be arranged in the first axial direction. The first member 331 and the second member 340 may be arranged in a straight line, for example. Alternatively, a portion of the first member 331 may be arranged in a second axial direction crossing the first axial direction with the second member 340.

The first operating portion 330 may further include a cover 349 coupled to the second member 340. The cover 349 may be formed of a material different from that of the second member 340. The cover 349 may be formed of a soft material or a flexible material. For example, the cover 349 may be formed of a rubber material or a silicone material.

The cover 349 may be in contact with the door 20 during an operation of the first operating portion 330. The cover 349 may reduce damage to the door 20 and noise caused by friction with the door 20. As another example, a portion of the second member 340 may be formed of a soft material or a flexible material.

The door opening and closing device 30 may further include a first elastic member 370. The first elastic member 370 may connect the second member 340 and the frame 310.

The door opening and closing device 30 may further include a second elastic member 372. The second elastic member 372 may connect the first member 331 and the second member 340. The second elastic member 372 may act to move the first member 331 and the second member 340 together in an automatic opening process of the door 20.

As long as no external force is applied, the first member 331 and the second member 340 may be in contact with the second elastic member 372. In the automatic opening process of the door 20, the first member 331 and the second member 340 may move in a contacted state.

The first elastic member 370 may be a coil spring. The second elastic member 372 may be a coil spring. A length of the first elastic member 370 may be the same as or different from a length of the second elastic member 372. Since a movement distance of the first operating portion 330 in the automatic opening process is greater than a movement distance of the first member 331 in the automatic closing process, a length of the first elastic member 370 may be greater than a length of the second elastic member 372.

As another example, at least one of the first elastic member 370 or the second elastic member 372 may be a torsion spring or a plate spring.

The second operating portion 400 may further include a link gear 360. The link gear 360 may be selectively connected to the sixth gear 356.

The second operating portion 400 may include a link 410. The link 410 may be connected to the link gear 360. For example, the link 410 may be rotatably connected to the link gear 360. At least a portion of the link 410 may be rounded. That is, the link 410 may include a curved portion. Alternatively, the link 410 may also include a straight portion.

The link gear 360 may include a gear portion 362. The gear portion 362 may be selectively connected to the second portion 356b of the sixth gear 356.

The link gear 360 may further include an arm portion 364. One side of the link 410 may be rotatably connected to the arm portion 364.

The link 410 may be rotatably connected to the link gear 360 at a position spaced apart from the rotational center C1 of the link gear 360.

A receiving groove 365 in which a portion of the link 410 is received may be formed at one side of the link gear 360. For example, the receiving groove 365 may be formed as an upper surface of the link gear 360 is recessed downward.

In a state in which a portion of the link 410 is received in the receiving groove 365, one end of the link 410 may be rotatably connected to the link gear 360 by a first pin 421.

In a state in which the door 20 is closed, a portion of the link 410 may overlap the arm portion 364 in a vertical direction.

Another end of the link 410 may be rotatably connected to the door 20 by a connection device 460.

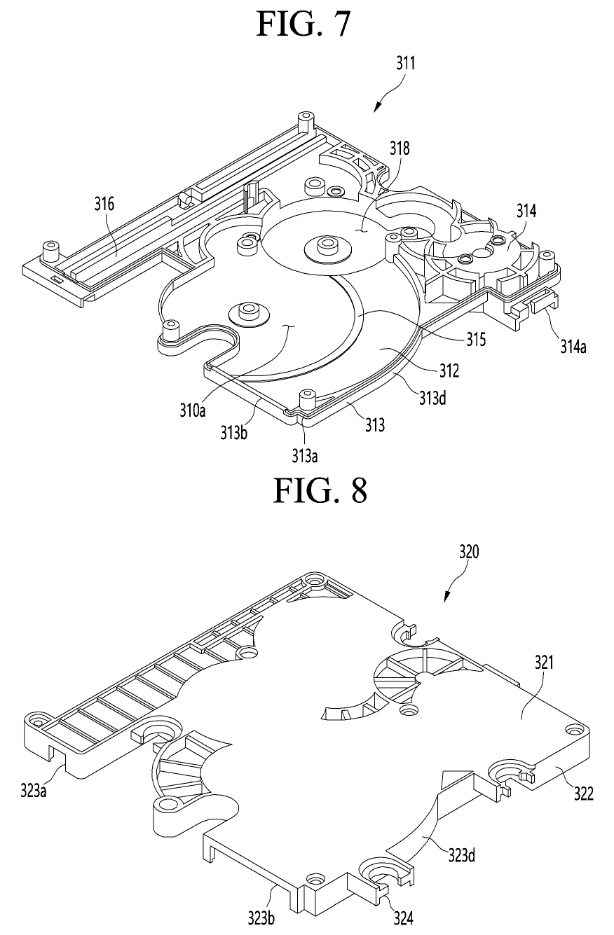

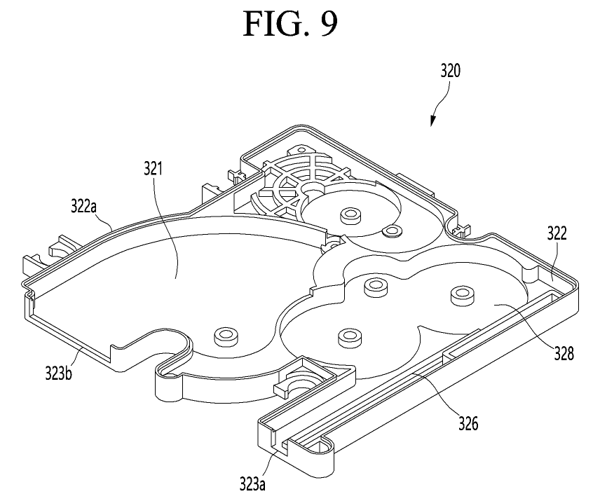

FIG. 6 is a front view of a door opening and closing device according to a first embodiment. FIG. 7 is a perspective view of a first frame according to a first embodiment. FIGS. 8 and 9 are perspective views of a second frame according to a first embodiment.

Referring to FIGS. 5 to 9, the frame 310 may include a first frame 311. The frame 310 may further include a second frame 320. The second frame 320 may be coupled to the first frame 311. For example, the second frame 320 may be coupled to an upper side of the first frame 311.

When the first frame 311 and the second frame 320 are coupled, a space 310a to receive one or more of the first operating portion 330, the power transmission portion 340, and the second operating portion 400 may be formed. For example, the link gear 360 may be received in the space 310a. A portion of the link 410 may be received in the space 310a.

The second frame 320 may be coupled to the cover member 110. Of course, it is also possible for the first frame 311 to be coupled to the cover member 110.

The first frame 311 may include a first frame body 312. The first frame 311 may include a first peripheral portion 313 extending from the first frame body 312. For example, the first peripheral portion 313 may extend upward from the first frame body 312.

The first peripheral portion 313 may include a first stepped portion 313a. The first stepped portion 313amay be formed as a portion of a rim of the first peripheral portion 313 is recessed downward.

A cover portion 313b may be provided at the first peripheral portion 313. The cover portion 313b may cover a portion of a second opening to be described later.

The first peripheral portion 313 may include a link cover portion 313d that covers a portion of the link 410 during an opening and closing process of the door 20. The link cover portion 313d may be formed in a curved shape. Accordingly, a size of the first frame 311 can be reduced.

The first frame 311 may include a mounting portion 314 where the driver 302 is installed. The driver 302 may be mounted to the mounting portion 314 from an outside of the mounting portion 314. The driver 302 may be positioned outside the space 310aformed by the frame 310.

At least a portion of the mounting portion 314 may protrude from the first frame body 312 toward the second frame 320. Accordingly, in a state in which the driver 302 is installed at the mounting portion 314, a protrusion of the driver 302 to an outside of the first frame 311 can be reduced.

The first frame 311 may further include a printed circuit board (PCB) mounting portion 314a where the driver printed circuit board (PCB) 304 is installed.

The first frame 311 may further include a guide 316 to guide a movement of the first operating portion 330. For example, the guide 316 may protrude from the first frame body 312. As another example, in a case in which the first operating portion 330 includes a boss, the guide 316 may be formed in a groove shape to receive the boss.

The first frame 311 may further include a protrusion 315 protruding from the first frame body 312. The protrusion 315 may be formed in an arc shape based on a rotational center of the link gear 360. Alternatively, a plurality of protrusions 315 may be arranged spaced apart from each other. A line connecting the plurality of protrusions 315 may be a curve.

For example, the protrusion 315 may protrude upward from the first frame body 312. The protrusion 315 may prevent sagging of the link gear 360 when the link gear 360 rotates.

In a state in which the link 410 is coupled to the door 20, if sagging of the door 20 occurs, a portion of the link 410 close to the door 20 moves downward together with the door 20, but a portion of the link 410 positioned farther from the door 20 and/or the link gear 360 is lifted upward.

When a portion of the link 410 positioned farther from the door 20, for example, the first pin 421, is lifted upward, the first pin 421 may frictionally engage with one surface of the frame 310. However, according to the present embodiment, a downward movement of the link gear 360 or the link 410 can be reduced by the protrusion 315 protruding from the first frame body 312. Accordingly, direct friction between the link gear 360 or the link 410 and the frame 310 can be reduced.

The protrusion 315 may be positioned closer to the link cover portion 313d than the rotational center C1 of the link gear 360.

The first frame 311 may further include a receiving portion 318 to receive some gears among a plurality of gears. For example, the fourth gear 354 may be received in the receiving portion 318, but is not limited thereto.

One end of the protrusion 315 may be positioned adjacent to the receiving portion 318, and another end of the protrusion 315 may be positioned adjacent to the cover portion 313b.

The second frame 320 may include a second frame body 321. The second frame 320 may further include a second peripheral portion 322 extending from the second frame body 321. For example, the second peripheral portion 322 may extend downward from the second frame body 321.

The second peripheral portion 322 may include a second stepped portion 322a. The second stepped portion 322a may be formed as a portion of a rim of the second peripheral portion 322 protrudes upward. Accordingly, the second stepped portion 322a may be coupled in a manner that engages with the first stepped portion 313a.

The second peripheral portion 322 may include a first opening 323athat provides a movement path of the first operating portion 330. An opening may or may not be formed in the first peripheral portion 313.

The second peripheral portion 322 may include a second opening 323b (or link opening 323b) that provides a movement path of the link 410.

A horizontal width of the second opening 323b may be formed greater than a horizontal width of the link 410.

The second peripheral portion 322 may include a link cover portion 323d that covers a portion of the link 410 during the opening and closing process of the door 20. The link cover portion 323d may be formed in a curved shape. Accordingly, a size of the second frame 320 can be reduced.

In a case of the present embodiment, movement of foreign substances to the connection portion between the link gear 360 and the link 410 can be prevented by the link cover portions 313d and 323d. In addition, damage to the link 410 by surrounding structures can be prevented.

In the present embodiment, a portion of the first frame body 312 may also serve as a link cover portion that covers a lower side of the link 410. A portion of the second frame body 321 may also serve as a link cover portion that covers an upper side of the link 410.

The second frame 320 may further include a guide 326 to guide a movement of the first operating portion 330. For example, the guide 326 may protrude from the second frame body 321. As another example, in a case in which the first operating portion 330 includes a boss, the guide 326 may be formed in a groove shape to receive the boss.

At an initial position of the first operating portion 330, a portion of the first operating portion 330 may be positioned outside the frame 310. For example, the cover 349 may be positioned outside the frame 310.

The second frame 320 may further include a receiving portion 328 in a recessed shape to receive a portion of the power transmission portion 350.

Meanwhile, referring to FIG. 6, the link 410 may pass through the second opening 323b. The cover portion 313b of the first frame 311 may be inserted into the second opening 323bfrom a lower side of the link 410. That is, the cover portion 313bof the first frame 311 may shield a portion of the second opening 323b. At this time, the cover portion 313bmay be spaced apart from the link 410.

According to the present embodiment, since the cover portion 313b of the first frame 311 shields a portion of the second opening 323b, exposure of the space 310a of the frame 310 to the outside can be reduced. That is, exposure of internal components of the frame 310 to an outside can be reduced.

In addition, since the cover portion 313b of the first frame 311 shields a portion of the second opening 323b, an entry of foreign substances into the space 310a of the frame 310 can be reduced.

In order to prevent the link 410 from interfering with the frame 310 while reducing a gap between the link 410 and the surface forming the second opening 323b, a gap (for example, a vertical gap) between the upper surface forming the second opening 323b and the link 410 may be less than a vertical length or height of the link 410.

A gap (for example, a vertical gap) between the cover portion 313b and the link 410 may be less than the vertical length or height of the link 410.

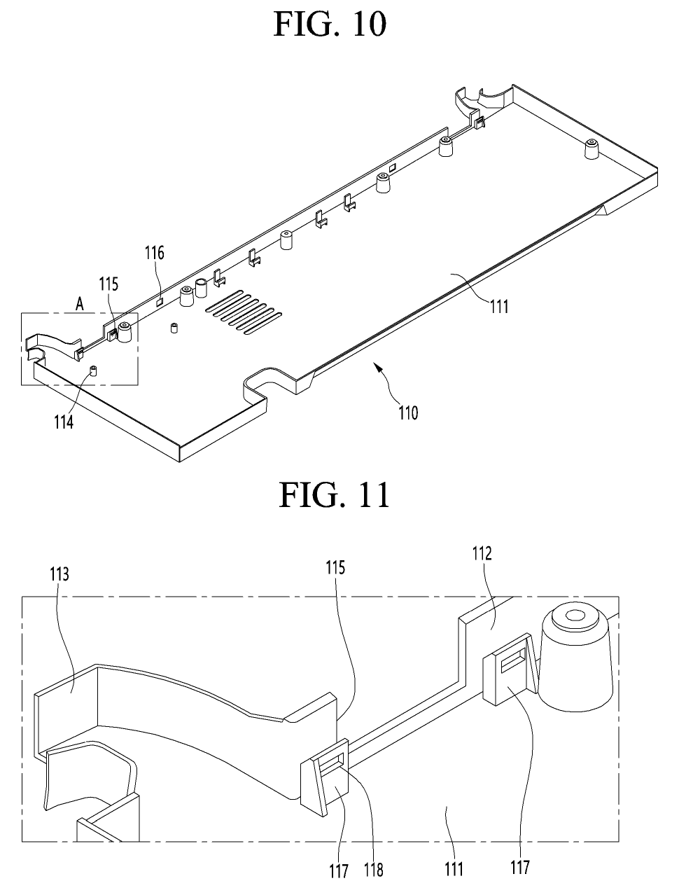

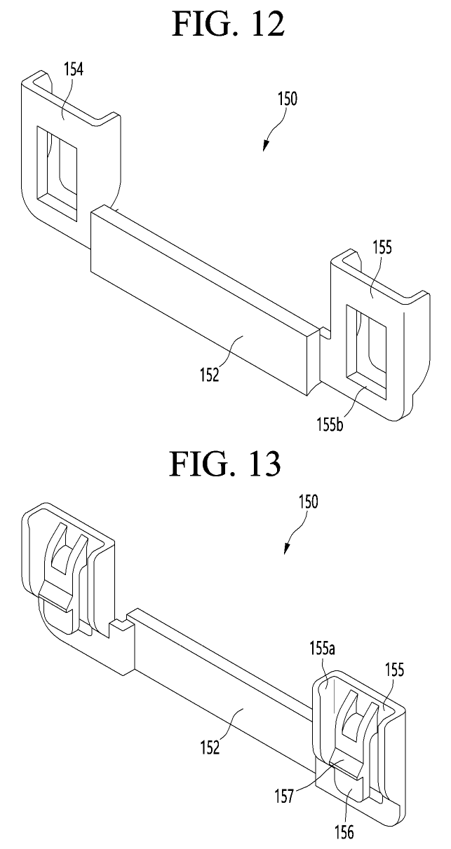

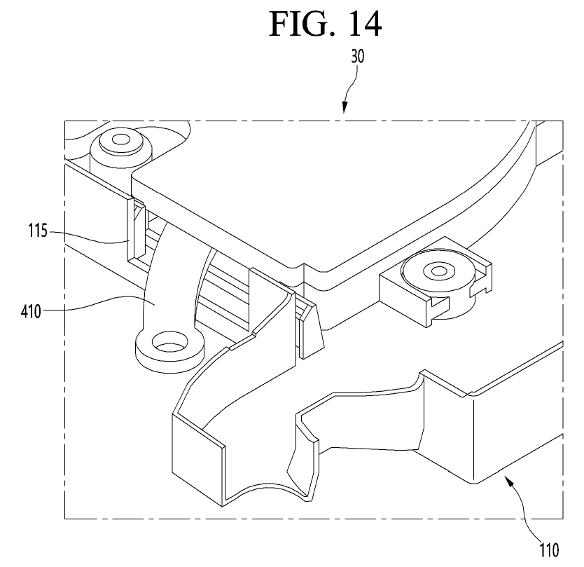

FIG. 10 is a perspective view of a cover member according to a first embodiment. FIG. 11 is an enlarged view of portion A of FIG. 10. FIGS. 12 and 13 are perspective views of a shielding member according to a first embodiment.

Referring to FIGS. 10 to 13, the cover member 110 may include a cover body 111 and a peripheral portion 112 extending from the cover body 111.

The cover member 110 may further include a coupling boss 114. The buffer member 32 may be coupled to the coupling boss 114. For example, the coupling boss 114 may be formed at the cover body 111.

The cover member 110 may further include a first slot 115. The first slot 115 may be formed at the peripheral portion 112. The first slot 115 may provide a space for the link 410 to be positioned or to move.

The first slot 115 may be formed as an end of the peripheral portion 112 is recessed toward the cover body 111. For example, it may be formed as a lower end of the peripheral portion 112 is recessed upward. Alternatively, the first slot 115 may pass through the peripheral portion 112.

The cover member 110 may further include a second slot 116. The second slot 116 may be formed at the peripheral portion 112. The second slot 116 may provide a space for the first operating portion 330 to be positioned or to move.

The hinge cover 113 may be positioned adjacent to the first slot 115. The first slot 115 may be positioned between the hinge cover 113 and the second slot 116.

The refrigerator 1 may further include a shielding member 150. The shielding member 150 may shield a portion of the first slot 115. The shielding member 150 may be coupled to the cover member 110.

The cover member 110 may further include a first coupling portion 117 to which the shielding member 150 is coupled. For example, a plurality of first coupling portions 117 may be arranged spaced apart from each other.

The first slot 115 may be arranged to face an area between the two first coupling portions 117 spaced apart from each other.

The first coupling portion 117 may be formed at the cover body 111. The first coupling portion 117 may be spaced apart from the peripheral portion 112. The first coupling portion 117 may include a coupling hole 118.

The shielding member 150 may include a shielding body 152. The shielding body 152 may be inserted into the first slot 115.

The shielding member 150 may further include a second coupling portion 154 to be coupled with the first coupling portion 117. The second coupling portions 154 may be provided at both ends of the shielding body 152, respectively.

At least a portion of the second coupling portion 154 may be inserted into a space between the peripheral portion 112 and the first coupling portion 117.

The second coupling portion 154 may include a first wall 155 stepped from the shielding body 152. A through-hole 155b may be formed in the first wall 155.

The second coupling portion 154 may further include a hook 156 extending from the first wall 155. The hook 156 may extend in a direction away from the first wall 155 and then be bent. A portion of the hook 156 may face the through-hole 155b.

The hook 156 may include a protrusion 157 to be inserted into the coupling hole 118. The hook 156 may be elastically deformable with respect to the first wall 155.

The second coupling portion 154 may further include a second wall 155a bent from the first wall 155. The second wall 155a may be formed by being bent from one end of the first wall 155 or may be formed by being bent from both ends thereof.

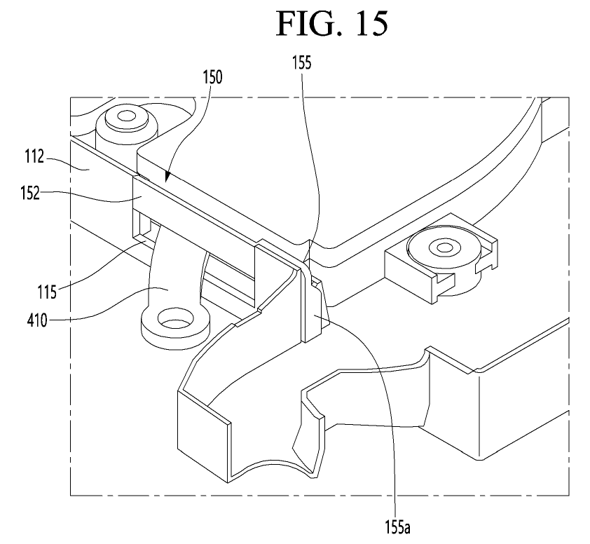

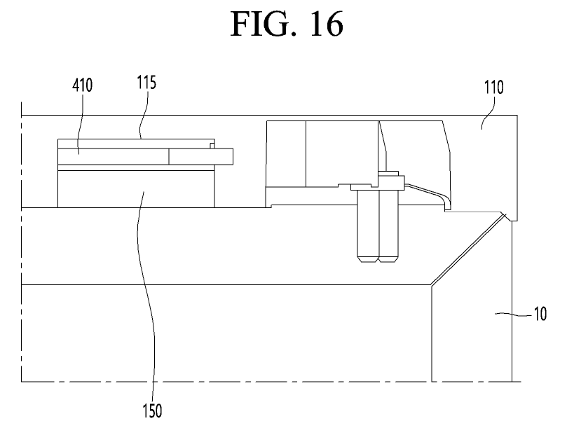

FIG. 14 is a view partially illustrating a state in which a door opening and closing device is coupled to the cover member according to a first embodiment. FIG. 15 is a view illustrating a state in which a shielding member is coupled in FIG. 14. FIG. 16 is a front view illustrating a state in which a cover member is installed at a refrigerator according to a first embodiment.

Referring to FIGS. 3 and 10 to 16, when the door opening and closing device 30 is installed at the cover member 110, the link 410 may be positioned in the first slot 115.

When the door opening and closing device 30 is installed at the cover member 110, the first operating portion 330 may be positioned in the second slot 116. For example, the cover 349 may be positioned in the second slot 116.

In a state in which the door opening and closing device 30 is installed at the cover member 110, the shielding member 150 may be coupled to the cover member 110.

In order to couple the shielding member 150 to the cover member 110, the shielding body 152 may be aligned with the first slot 115. The first wall 155 and the hook 156 may be aligned with a space between the first coupling portion 117 and the peripheral portion 112.

In this state, the shielding member 150 may be moved in a direction in which the shielding body 152 is inserted into the first slot 115. Then, the shielding body 152 may be inserted into the first slot 115. In addition, the first wall 155 and the hook 156 may be inserted into the space between the first coupling portion 117 and the peripheral portion 112.

In a process in which the hook 156 is inserted into the space between the first coupling portion 117 and the peripheral portion 112, the hook 156 may be elastically deformed. When the protrusion 157 is aligned with the coupling hole 118, the hook 156 returns to an original shape, and the protrusion 157 is inserted into the coupling hole 118, whereby the coupling of the shielding member 150 can be completed.

In a state in which the shielding member 150 is coupled to the cover member 110, the second wall 155a may be in contact with the first coupling portion 117 or may face one surface of the first coupling portion 117.

In a state in which the shielding member 150 is coupled to the cover member 110, the cover member 110 may be coupled to the cabinet 10.

In a state in which the shielding member 150 is coupled to the cover member 110, the shielding body 152 is positioned at a lower side of the link 410 and may be spaced apart from the link 410.

A gap (for example, a vertical gap) between the shielding body 152 and the link 410 may be less than a vertical length or height of the link 410.

According to the present embodiment, since the shielding member 150 shields the first slot 115, movement of foreign substances to the door opening and closing device 30 through the first slot 115 can be reduced, and external exposure of the door opening and closing device 30 can be reduced.

In addition, according to the present embodiment, when the door opening and closing device 30 is installed at the cover member 110, the cover 349 can be positioned in the second slot 116, so that movement of foreign substances to the door opening and closing device 30 through the second slot 116 can be reduced, and external exposure of the door opening and closing device 30 can be reduced.

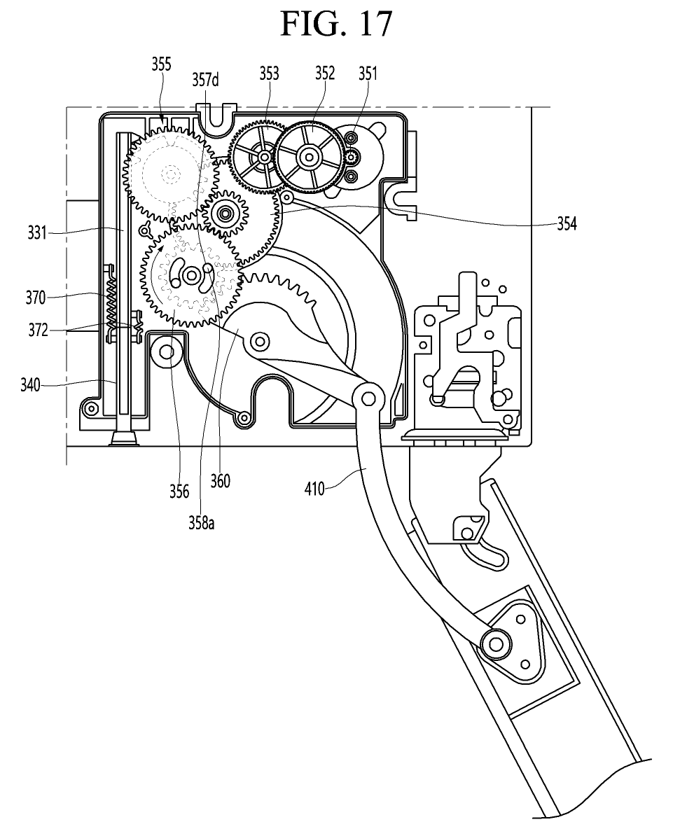

FIG. 17 is a plan view illustrating a door opening and closing device in a state in which a door is opened by a maximum opening angle according to a first embodiment.

Referring to FIGS. 3, 8, and 17, in a state in which the door 20 is closed, the link 410 may be positioned at an initial position. In a state in which the door 20 is opened by a maximum opening angle, the link 410 may be positioned at a door opening position.

As shown in FIG. 3, at the initial position of the link 410, the link 410 may be positioned adjacent to one side end (the left end in the drawing) of the second opening 323b.

In the state in which the door 20 is closed, a portion of the gear portion 362 may be positioned between the first operating portion 330 and the rotational center C1 of the link gear 360.

In the state in which the door 20 is closed, the rotational center C1 of the link gear 360 may be positioned between a portion of the gear portion 362 and the link 410. Accordingly, exposure of the gear portion 362 to the outside through the second opening 323b can be reduced.

As shown in FIG. 17, at the door opening position of the link 410, the link 410 may be positioned adjacent to the other side end (a right end in the drawing) of the second opening 323b. The one side end and the other side end may be spaced apart from each other in a horizontal direction.

A position of the link 410 may be variable relative to the second opening 323b until the link 410 is moved from the initial position to the door opening position, while interference with the frame 310 can be prevented.

In a case in which the link 410 includes a curved portion, until the link 410 is moved from the initial position to the door opening position, the link 410 can reduce exposure of the space 310a of the frame 310 to the outside through the second opening 323b from the inside or outside of the frame 310 while a position of the link 410 is varied relative to the second opening 323b.

Hereinafter, a process of opening and closing the door will be described.

A controller (not shown) may control the driver 302. Through an input portion, a door opening command for opening the door 20 may be input.

The input portion may include a touch sensor that detects a user's touch on a front surface of the door 20, or a knock sensor that detects multiple knocks applied to a front surface of the door 20. Alternatively, the input portion may include a capacitance sensor, a sensor that detects vibration, or a sensor that detects sound waves. Alternatively, the input portion may include a mechanical button or a touch screen capable of inputting a user's command.

In a state in which the door 20 is closed, the first operating portion 330 and the second operating portion 400 may be positioned at initial positions. In the state in which the door 20 is closed, a door opening command may be input from the input unit.

Then, the controller may control the driver 302 for automatic opening of the door 20. For example, the driver 302 may operate in a forward direction.

The controller may, for example, rotate the motor in a forward direction. When the motor rotates in the forward direction, a power of the motor may be transferred to the first operating portion 330 by the power transfer portion 350.

In the initial position of the first operating portion 330 or the initial position of the fifth gear 355, the fifth gear 355 and the first operating portion 330 are in a disconnected state. In the initial position of the sixth gear 356, the sixth gear 356 is in a disconnected state from the link gear 360.

In a process in which the fifth gear 355 rotates, the second portion 355b of the fifth gear 355 and the first operating portion 330 become in a connected state. In this state, when the fifth gear 355 further rotates, the first operating portion 330 moves in a first direction (or an extending direction or a door opening direction) from the initial position toward a final position.

Since the first member 331 and the second member 340 are in a connected state by the second elastic member 372, when the first member 331 moves in the first direction by the rotation of the fifth gear 355, the second member 340 may move together in the first direction.

When the first operating portion 330 moves in the first direction, the first operating portion 330 may be in contact with a rear surface of the door 20. Even when the first operating portion 330 is in contact with the rear surface of the door 20, the second operating portion 400 remains in a stopped state. That is, when the fifth gear 355 rotates, the sixth gear 356 also rotates, but the second portion 356b of the sixth gear 356 is not yet connected to the link gear 360.

When the first operating portion 330 is further moved in the first direction, the first operating portion 330 pushes the door 20, causing the door 20 to be automatically rotated in an opening direction. Accordingly, at least a portion of the gasket 220 begins to separate from the cabinet 10.

When the second portion 356b of the sixth gear 356 is connected to the link gear 360 by further rotation of the sixth gear 356, the link gear 360 may rotate.

After the door 20 starts to open from the closed state and until the sixth gear 356 and the link gear 360 are rotated together, the link gear 360 may be rotated by a rotational force of the door 20 rotated by the first operating portion 330.

When the link gear 360 rotates, the link 410 may move from an initial position toward a door opening position. During a movement of the link 410, the door 20 may be automatically opened by the link 410.

In a process of additionally moving in the first direction in a state in which the first operating portion 330 is in contact with a rear surface of the door 20, the link 410 moves, so that the door 20 may be rotated by the link 410 and the first operating portion 330 may be spaced apart from the rear surface of the door 20.

By additional movement of the link 410, an opening angle of the door 20 increases, and the gasket 220 may be completely separated from the cabinet 10.

In the present embodiment, the door opening and closing device 30 operates so that the gasket 220 is separated from the cabinet 10 at an initial process of automatic opening of the door 20.

The second operating portion 400 may operate before the gasket 220 is completely separated from the cabinet 10 by operating the first operating portion 330.

Even when the first operating portion 330 is spaced apart from the rear surface of the door 20, the first operating portion 330 may move toward a final position in the first direction.

When the first operating portion 330 reaches the final position, one surface of the first operating portion 330 may be in contact with the frame 310, so that a movement of the first operating portion 330 can be restricted.

The first elastic member 370 may be tensioned until the first operating portion 330 reaches the final position from the initial position.

When an automatic opening of the door 20 begins and the fifth gear 355 is rotated by a predetermined angle or more, the fifth gear 355 and the first operating portion 330 may be disconnected.

When the fifth gear 355 and the first operating portion 330 are in a disconnected state, an external force acting on the first operating portion 330 is removed, so that the first operating portion 330 may move in a second direction opposite to the first direction by an elastic force of the first elastic member 370. That is, the first operating portion 330 may move from the final position to the initial position in the second direction by the elastic force of the first elastic member 370.

When the first operating portion 330 moves to the initial position, another surface of the first operating portion 330 may be in contact with a portion of the frame 310, so that a movement of the first operating portion 330 may be restricted.

The second operating portion 400 may continuously move in the opening direction while the first operating portion 330 is stopped.

When the second operating portion 400 continuously moves in the opening direction to move to the door opening position, an opening angle of the door 20 becomes maximum. In the present embodiment, a maximum opening angle (or set angle) of the door 20 may be greater than 90 degrees.

When the maximum opening angle of the door 20 is 90 degrees or more, there is an advantage in that the user can easily access the storage space 12 without having to manually open the door 20 additionally.

The controller may determine whether an automatic opening of the door 20 is completed. If it is determined that the automatic opening of the door 20 is completed, the controller may stop the driver 302.

In a state in which the driver 302 is stopped after automatic opening of the door 20 is completed, for automatic closing of the door 20, if a closing command for the door 20 is detected or recognized, such as when a set time elapses after the door 20 is opened, when a user is not detected after the door 20 is opened, or when a separate door closing command is input, the controller may cause the driver 302 to operate in a reverse direction. That is, the controller may control the motor to rotate in a reverse direction.

When the motor rotates in the reverse direction, power of the motor is transmitted to the second operating portion 400 by the link gear 360, so that the second operating portion 400 can move from the door opening position to the initial position in a closing direction.

In the process in which the door 20 is opened, since the fifth gear 355 and the first operating portion 330 become in a disconnected state, the first operating portion 330 maintains a stopped state during a portion of a door closing process of the door 20.

In a process of the motor rotating in the reverse direction, the fifth gear 355 rotates in the reverse direction. In a process of the fifth gear 355 rotating in the reverse direction, the second portion 355b of the fifth gear 355 may be in contact with a rack gear of the first operating portion 330.

The second portion 355b of the fifth gear 355 may be in contact with the rack gear before the door 20 is completely closed.

In this state, if the fifth gear 355 is further rotated in the reverse direction, a rotational force of the fifth gear 355 may be transferred to a rack gear of the first operating portion 330. Then, the first member 331 may move in a second direction in a state in which the second member 340 is stopped.

During a process in which the first member 331 moves in the second direction, the door 20 may be completely closed.

When the first member 331 moves in the second direction, the first member 331 and the second member 340 may be spaced apart by a predetermined distance. The predetermined distance may be a movement distance of the first member 331.

After the first member 331 is separated from the second member 340, if the fifth gear 355 is further rotated in the reverse direction, the first operating portion 330 and the fifth gear 355 may be in a disconnected state. In this case, the first member 331 may return to an original position by an elastic force of the second elastic member 372. That is, the first member 331 may move in the first direction and be in contact with the second member 340.

After the first member 331 is separated, if the fifth gear 355 is further rotated in the reverse direction, the first operating portion 330 and the fifth gear 355 may be reconnected. In this state, when the fifth gear 355 is rotated in the reverse direction, the first member 331 may move in the second direction and be spaced apart from the second member 340.

Since a number of gear teeth formed in the second portion 355b of the fifth gear 355 is plural, a number of times the first member 331 moves in the second direction and then returns to an original position may be equal to a number of gear teeth.

A process of the first member 331 moving in the second direction and then returning to the original position until the fifth gear 355 moves to the initial position may be repeated. In a state in which the fifth gear 355 is moved to the initial position, the fifth gear 355 may be disconnected from the first operating portion 330.

If a stop condition of the driver 302 is satisfied while the driver 302 is operating, the controller may stop the driver 302. For example, the driver 302 may be stopped in a state in which the fifth gear 355 has moved to the initial position.

As another example, it is also possible that the first member 331 and the second member 340 are integrally formed. That is, in a case in which the first operating portion 330 is designed not to interfere with the frame 310, the entire first operating portion 330 may move in the second direction. In this case, the second elastic member 372 may be omitted.

According to the present embodiment, at an initial process of an automatic opening process of the door, a power of the driver is transferred to the first operating portion and used for separating the gasket, and during or after a separation of the gasket, the power of the driver is used as an opening force of the door. Therefore, the door gasket may be easily separated during an initial opening process. Furthermore, since a power of the driver is not directly transferred to the link for door opening, an overload on the driver during the initial opening process can be reduced.

In this embodiment, the door not only opens automatically, but also closes automatically, providing enhanced user convenience.

### Manual Opening Process of Door

A user can manually open the door 20 in a state in which the door 20 is closed.

As described above, in a state in which the door 20 is closed, since the link gear 360 is in a disconnected state, even if the link gear 360 rotates, a rotational force of the link gear 360 is not transferred to the sixth gear 356. That is, an initial position of the sixth gear 356 may be a disconnected position.

When a user holds a handle of the door 20 and pulls the door 20, the door can be rotated. When the door 20 is rotated in an opening direction, the second operating portion 400 connected to the door 20 moves together with the door 20. During a manual opening process of the door 20, the second operating portion 400 may be moved to a door opening position by a rotational force of the door 20.

When the second operating portion 400 moves together with the door 20, the link gear 360 connected to the second operating portion 400 rotates. However, since the sixth gear 356 is positioned at a disconnected position, the sixth gear 356 does not rotate even if the link gear 360 rotates.

Therefore, in a manual opening process of the door 20, a manual rotational force of the door 20 is not transferred to the sixth gear 356. The sixth gear 356 is connected to the driver 302 by gears, but the rotational force of the door 20 is not transferred to the driver 302. Accordingly, a load can be prevented from being applied to the driver 302. In addition, since the rotational force of the door 20 is not transferred to the first to sixth gears 351 to 356 during the manual opening process of the door 20, noise generation due to rotation of the gears can be prevented.

Even when the user closes the door 20, the link gear 360 may rotate, but the sixth gear 356 may remain in a stopped state.

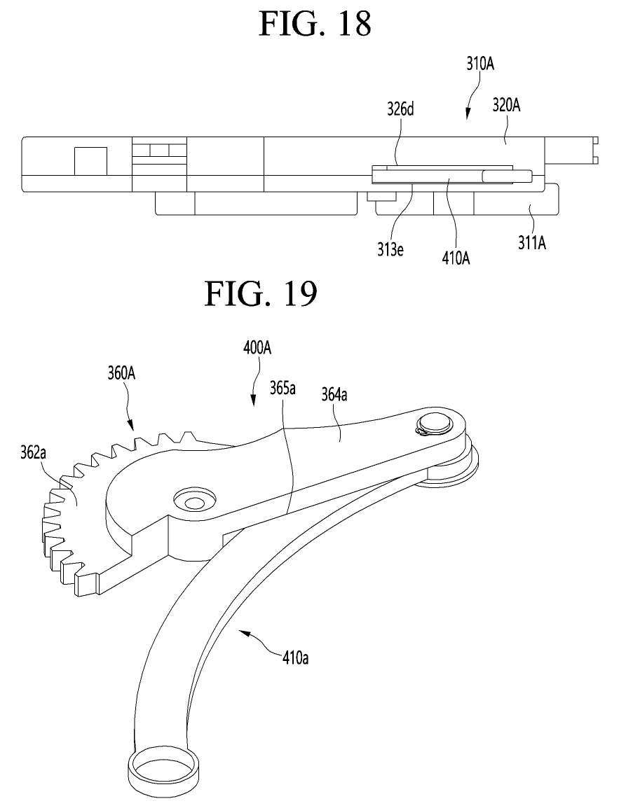

FIG. 18 is a front view of a door opening and closing device according to a second embodiment. FIG. 19 is a perspective view of a second operating portion according to a second embodiment.

The present embodiment is identical to the first embodiment in other respects, except that it differs a shape of the second operating portion and a second opening formed in the frame. Accordingly, hereinafter, only characteristic portions of the present embodiment will be described.

Referring to FIGS. 18 and 19, the second operating portion 400A may include a link gear 360A and a link 410a rotatably connected to the link gear 360A.

The link gear 360A may include a gear portion 362a and an arm portion 364a. The link 410a may be rotatably connected to the arm portion 364a.

A receiving groove 365a may be formed in the arm portion 364a. A portion of the link 410a may be received in the receiving groove 365a.

For example, the receiving groove 365a may be formed as one surface of the link gear 360A is recessed upward.

Accordingly, a portion of the link 410a may be positioned at a lower side of the link gear 360A.

Corresponding to such an arrangement of the link gear 360A and the link 410a, the first frame 311A may include an opening 313e providing a path of the link 410a. The second frame 320A may include an opening 326d providing a path of the link 410a. The opening 313e of the first frame 311A and the opening 326d of the second frame 320A may be aligned, for example, in a vertical direction.

A portion of the link 410a may be positioned in the opening 313e of the first frame 311A, and another portion of the link 410a may be positioned in the opening 326d of the second frame 320A. Surfaces forming the openings 313e and 326d may be spaced apart from the link 410a.

A vertical length (or height) of the opening 326d of the second frame 320A may be less than a vertical length (or height) of the link 410a.

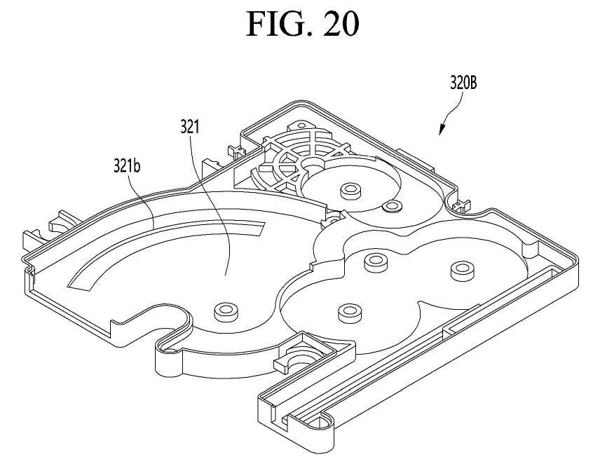

FIG. 20 is a perspective view of a second frame according to a third embodiment.

The present embodiment is identical to the first embodiment in other respects, except that it differs that a groove is formed in the second frame. Hereinafter, only characteristic portions of the present embodiment will be described.

Referring to FIG. 20, the second frame 320B may include a groove 321b. For example, the groove 321b may be formed by being recessed in a direction away from the first frame 311 in the second frame body 321. For example, the groove 321b may be formed as being recessed upward in the second frame body 321.

The groove 321b may be disposed at a position facing the first pin 421 (refer to FIG. 5).

In a process of opening and closing the door 20, the first pin 421 may move together with the link 410. To prevent the moving first pin 421 from interfering with the second frame 320B, at least a portion of the groove 321a may be formed in a shape identical to a movement trajectory of the first pin 421 at a position corresponding to the movement trajectory.

Therefore, according to the present embodiment, even if the first pin 421 moves upward due to sagging of the door 20, direct friction between the first pin 421 and the second frame 320B can be prevented.

What is claimed is:

1. A refrigerator comprising:
a cabinet having a storage space;
a door that opens and closes the storage space; and
a door opening and closing device to open and close the door,
wherein the door opening and closing device includes:
a frame,
a driver installed on the frame and configured to generate power,
a power transmission portion configured to transmit the power from the driver,
a first operating portion configured to operate by receiving the power from the driver, and
a second operating portion configured to operate by receiving the power from the driver to open the door to a preset angle,
wherein the second operating portion includes a link gear connectable to the power transmission portion, and a link having one side rotatably connected to the link gear and another side rotatably connected to the door,
wherein the frame includes a first frame and a second frame coupled to the first frame,
wherein the second frame includes an opening that provides a path for the link to move, and
wherein the first frame includes a cover portion that covers a portion of the opening.

2. The refrigerator of claim 1,
wherein the second frame is positioned at an upper side of the first frame, and the link gear includes a receiving portion formed by one surface being recessed downward so that the link is positioned therein.

3. The refrigerator of claim 1,
wherein a gap between a surface of the second frame forming the opening and an upper surface of the link is less than a vertical length or a height of the link.

4. The refrigerator of claim 1,
wherein a gap between the cover portion and the link is less than a vertical length or a height of the link.

5. The refrigerator of claim 1,
wherein the first frame includes a first frame body and a first peripheral portion extending from the first frame body, and
wherein a protrusion for preventing sagging of the link gear or the link is formed on the first frame body.

6. The refrigerator of claim 5,
wherein the protrusion is formed in an arc shape based on a rotation center of the link gear.

7. The refrigerator of claim 5,
wherein the link is connected to the link gear by a pin,
a groove is formed at the second frame, and
at least a portion of the groove is formed in the same shape as a movement trajectory of the pin at a position corresponding to the movement trajectory.

8. The refrigerator of claim 1,
wherein the link gear includes a gear portion, and
when the door is in a closed state, a portion of the gear portion is positioned between the first operating portion and a rotation center of the link gear.

9. The refrigerator of claim 8,
wherein when the door is in the closed state, a rotation center of the link gear is positioned between the portion of the gear portion and the link.

10. The refrigerator of claim 1,
wherein at least one of the first frame or the second frame includes a link cover portion that covers the link.

11. The refrigerator of claim 1,
further comprising a cover member that covers at least a portion of the door opening and closing device and has a slot providing a path through which the link moves.

12. The refrigerator of claim 11,
further comprising a shielding member coupled to the cover member to shield a portion of the slot.

13. The refrigerator of claim 12,
wherein the cover member includes a cover body and a peripheral portion extending from the cover body, and
wherein the slot is formed at the peripheral portion, and
a first coupling portion for coupling with the shielding member is formed at the cover body.

14. The refrigerator of claim 13,
wherein the shielding member includes a shielding body to cover the slot and a second coupling portion coupled to the first coupling portion.

15. The refrigerator of claim 14,
wherein in a state in which the shielding body covers the slot, the shielding body is disposed spaced apart from the link at a lower side of the link.

16. The refrigerator of claim 13,
wherein the peripheral portion further includes an additional slot providing a movement path for the first operating portion,
wherein the first operating portion includes a cover formed of a soft or flexible material, and
wherein, in a state in which the door is closed, the cover covers the additional slot.

17. A refrigerator comprising:
a cabinet having a storage space;
a door that opens and closes the storage space; and
a door opening and closing device to open the door,
wherein the door opening and closing device includes:
a frame,
a driver installed on the frame to generate power,
a power transmission portion to transmit the power of the driver,
a first operating portion operating by receiving the power of the driver, and
a second operating portion operating by receiving the power of the driver to open the door to a set angle,
wherein the second operating portion includes a link gear connectable to the power transmission portion, and a link having one side rotatably connected to the link gear and another side rotatably connected to the door,
wherein the frame includes a first frame and a second frame coupled to the first frame, and
wherein each of the first frame and the second frame includes an opening that provides a path for the link to move.

18. The refrigerator of claim 17,
wherein a vertical length or a height of the opening of the second frame is less than a vertical length or a height of the link.

19. The refrigerator of claim 17,
wherein the second frame is positioned at an upper side of the first frame, and
wherein the link gear includes a receiving portion formed by one surface being recessed upward so that the link is positioned therein.

20. A refrigerator comprising:
a cabinet having a storage space;
a door that opens and closes the storage space;
a door opening and closing device to open the door; and
a cover member installed on the cabinet and covering at least a portion of the door opening and closing device,
wherein the door opening and closing device includes:
a frame,
a driver installed on the frame to generate power,
a power transmission portion to transmit the power of the driver,
a first operating portion operating by receiving the power of the driver, and
a second operating portion operating by receiving the power of the driver to open the door to a set angle,
wherein the second operating portion includes a link gear connectable to the power transmission portion, and a link having one side rotatably connected to the link gear and another side rotatably connected to the door,
wherein the frame includes an opening through which the link passes,
wherein the cover member includes a slot through which the link passing through the opening passes, and
wherein a portion of the slot is covered by a shielding member coupled to the cover member.
